(19) United States
(12) Patent Application Publication
(10) Pub. No.: US 2026/0089804 A1
(43) Pub. Date: Mar. 26, 2026

(54) RADIATING APPARATUS AND METHOD FOR MAKING IT

(71) Applicant: ESANANOTECH S.R.L. SB, Milan (IT)

(72) Inventors: Domenico CIRILLO, Caserta (IT); Tiziano MILANI, Montagnana (IT)

(21) Appl. No.: 19/111,427

(22) PCT Filed: Sep. 14, 2023
(86) PCT No.: PCT/IB2023/059121

§ 371 Date: Mar. 13, 2025

(30) Foreign Application Priority Data
Sep. 16, 2022 (IT) 102022000018969

(51) Int. Cl. H05B 3/12; H05B 3/16

(52) U.S. Cl. CPC H05B 3/12; H05B 3/16

(57) ABSTRACT

A radiating apparatus (1) for heating a workspace (SO) or an object (O), comprises:
a substrate material (11), configured to be attached to a structure of the workspace (SO) or to a surface of the object (O);
a conductor (10), associated with the substrate material (11) and configured to receive an electric current, the conductor (10) extending in a plane to define a radiating surface of the radiating apparatus (1),
   characterized in that the conductor (10) is a flat conductor made from a carbon-based material.

### TECHNICAL FIELD

This invention relates to a radiating apparatus and a method for making the radiating apparatus.

Radiating apparatuses are apparatuses configured for producing radiant heat by means of electric current flowing through a conductor and creating a Joule effect which generates heat.

These apparatuses comprise a frame with which the conductors are associated in a path which defines a radiating surface. In a radiating apparatus, the radiation emitting surface is called the active surface and the surface that does not emit radiation, and thus does not contribute to heating, is called the passive surface.

Generally speaking, these apparatuses have a planar shape which defines a radiating panel.

### BACKGROUND ART

In the sector of radiating apparatuses, two broad categories of radiating apparatuses are known.

A first category of radiating panels comprises radial conductors, basically wire windings forming the radiating surface.

Panels of this kind have several disadvantages. On the one hand, the size of the active surface is limited, since the surface cannot be excessively saturated with circular conductors and, on the other, the radial conductor produces radial radiation, not orthogonal to the radiating surface, with the result that a lot of energy is lost. In short, therefore, the energy efficiency of these radiating panels is rather low, around 40%.

The second category of radiating panels, on the other hand, is made using flat supporting sheets on which conductive polymers are laid. This solution, although it increases the size of the active surface, has some drawbacks which are all but negligible. First of all, these apparatuses are usually provided with bare electrical connections and cannot therefore be applied to exposed structures. Moreover, and more importantly, the working life of these apparatuses is relatively short, around three or four years. In effect, the operating principle of apparatuses of this kind is based on the movement (kinetic energy) of the polymer particles, which generates the heat. The fact that the radiation is the result of a dynamic situation of molecular motion leads to relatively rapid wear of the polymer.

In this regard, it should be remembered that in the building construction sector, current legislation relating to the installation of fixed components built into a structure require that a ten-year guarantee be provided. These apparatuses cannot therefore be used in contexts such as that, since their working life is much shorter.

Prior art apparatuses which have the disadvantages mentioned above are described in documents: GB2536214A, US2011056928A1 and CN111432507A.

### DISCLOSURE OF THE INVENTION

The aim of this invention is to provide a radiating apparatus and a method for making it to overcome the above mentioned disadvantages of the prior art.

This aim is fully achieved by the apparatus and method of this disclosure as characterized in the appended claims.

According to an aspect of it, this disclosure provides a radiating apparatus for heating a workspace and/or an object. Preferably, the apparatus is a radiating panel.

The apparatus comprises a substrate material. The substrate material is configured to be attached to a structure of the workspace or to a surface of the object.

The apparatus comprises a conductor. The conductor is associated with the substrate material. The conductor is configured to receive an electric current. The conductor extends in a plane to define a radiating surface of the radiating apparatus.

The conductor is configured to radiate the workspace or the object with the heat generated by the Joule effect created by the passage of the electric current in the conductor.

Preferably, the conductor is a flat conductor.

Using a flat conductor makes it possible to direct the radiation of the entire surface at the workspace, without wasting energy on account of radiation in different directions as occurs in the prior art.

In an embodiment, the conductor is made from a carbon-based material.

That means heating does not depend on molecular motion but on the Joule effect created by the passage of electrons, which is a “static” form of heating which allows the apparatus (the conductor) to have a longer working life, more in line with the ten-year guarantee requirement of building constructions.

In an embodiment, the conductor is made from graphene. In an embodiment, the substrate material is made from a polymeric material. Preferably, the substrate material is fireproof. Preferably, the substrate material is electrically insulating.

In an embodiment, the substrate material is made from a polyimide. An example of the material that can be used is Kapton®.

In an embodiment, the conductor is made, starting from the substrate material, by (nanometric) thermal conversion of the substrate material in the carbon-based material. This allows obtaining an extremely high level of flexibility in the manufacturing of the conductor, with nanometric based conductor structuring and with practically no limitation on the shape of the conductor.

It is specified that using the thermal conversion process gives the conductor special structural properties which allow recognizing the graphene thus made, compared to other types of graphene made using different methods. Thus, the method used has direct effects on the graphene used and can be made the object of product protection.

In an embodiment, the conductor comprises a continuous sheet that defines the radiating surface of the radiating apparatus.

In an embodiment, the continuous sheet has a thickness of less than 50 microns. In an embodiment, the continuous sheet has a thickness of less than 30 microns, preferably 25 microns.

In an embodiment, the continuous sheet is flexible (pliable) so it can adapt to the surface of an object it is placed on.

In an embodiment, the apparatus comprises one or more attaching elements, configured to attach the substrate material to an object to be heated. For example, the attaching elements might be adhesive strips which adhere to the object to be heated.

In an embodiment, the apparatus comprises a framework on which the conductor is disposed (associated, attached, connected, fastened, supported). In particular, the framework is configured to support the continuous sheet. In an embodiment provided with the framework, there may be a plurality of continuous sheets parallel to each other and spaced along a radiating direction to increase the heat radiated by each panel.

In a further embodiment, the conductor comprises a straight conductor. The straight conductor is preferably flat. The straight conductor is wrapped on (around) the framework to define the radiating surface.

In an embodiment, the framework comprises a frame. The frame comprises four side walls. The framework comprises a plurality of through cavities. The plurality of through cavities are made in at least two of the side walls of the frame. The straight conductor is wrapped on the framework. The straight conductor is inserted in the through cavities of the frame to form respective spirals. That way, a coil which radiates heat is defined.

The through cavities are spaced along the radiating direction to define respective spaces between the respective spirals defined by the straight, wrapped conductor, thereby reducing heat transmission towards the side of the apparatus opposite that where the workspace is located.

Preferably, the straight conductor is made according to the embodiment described below, offering several advantages in terms of reducing the noise created by magnetic and/or electrical fields.

In particular, the (flat) straight conductor comprises a first (flat) conductor. The first flat conductor is encapsulated (contained, housed, disposed, insulated) in the substrate material. The first flat conductor is traversed by a first electric alternating current.

The (flat) straight conductor comprises a second flat conductor. The second flat conductor is encapsulated (contained, housed, disposed, insulated) in the substrate material. The second flat conductor is traversed by a second electric alternating current.

Preferably, the sense of the second electric alternating current is the opposite of that of the first electric alternating current. The modulus of the first electric alternating current is the same as that of the second electric alternating current. Furthermore, the first and the second conductor are overlaid on each other along the axis (relative to the axis) of thermal flow emission to define the (flat) straight conductor. The configuration of such a conductor allows zeroing the magnetic field since the first and the second alternating currents have opposite senses which create an induced magnetic field with opposite sense and equal modulus, thus causing the induced magnetic field to be zeroed. Furthermore, the presence of the electrically insulating substrate material allows the electrical field to be insulated.

It should also be noted that this disclosure does not, intentionally, provide any solutions for compensating (or avoiding) eddy currents. In effect, the eddy currents further increase conductor heating, thus contributing, to all intents and purposes, to increasing the resulting heating efficiency.

According to an aspect of it, this disclosure provides a structural element for building construction, comprising a structure. The structural element comprises the heating apparatus according to any of the features described in this disclosure. The apparatus is attached to the structure of the structural element. The structural element could be a floor, a column, a wall, a ceiling, a cabinet.

According to an aspect of it, this disclosure provides a method for making a radiating apparatus for heating a workspace or an object.

The method comprises a step of providing a substrate material.

The method comprises a step of disposing a conductor on the substrate material. The conductor is a flat conductor and/or is made from a carbon-based material.

Preferably, the step of disposing the conductor on the substrate material is a step of nanometric thermal conversion, wherein part of the substrate material is thermally converted into the carbon-based material of the conductor.

According to an aspect of it, this disclosure also provides a method for making a preferably flat, straight conductor.

The method for making a straight conductor comprises the following steps:
providing a strip of substrate material, preferably made from a polymeric material;
thermally converting a portion of the substrate material into a conductor, wherein the conductor is formed on a face of the substrate material and in an inner zone of the strip so that the conductor is spaced from a perimeter edge of the substrate material;
folding the strip around a longitudinal axis, defined by the direction of extension of the strip;
welding the overlaid edges of the substrate material to encapsulate, or insulate, the conductor;
folding the strip around a transverse axis, perpendicular to the longitudinal direction, to define two plies of the conductor;
welding (gluing) the two plies of the conductor, to define the linear conductor comprising a first straight conductor and a second straight conductor, parallel to each other along the longitudinal direction.

### BRIEF DESCRIPTION OF THE DRAWINGS

This and other features will become more apparent from the following description of a preferred embodiment, illustrated by way of non-limiting example in the accompanying drawings, in which:
FIGS. 1A and 1B show two schematic side views of an embodiment of a radiating apparatus for heating a workspace or an object according to this disclosure;
FIG. 2 shows a schematic side view of a further embodiment of the radiating apparatus of FIG. 1;
FIG. 3 shows a schematic plan view of the radiating apparatus of FIG. 1;
FIG. 4 shows a schematic plan view of the radiating apparatus of FIG. 2;
FIG. 5 shows a schematic side view of a straight conductor usable in the radiating apparatus according to this disclosure;
FIG. 6 shows a schematic plan view of a strip of substrate material on which a conductor is thermally converted;
FIG. 7 shows a schematic side view of an embodiment of the radiating apparatus according to this disclosure;
FIG. 8 schematically illustrates a workspace in which structural heating elements are disposed.

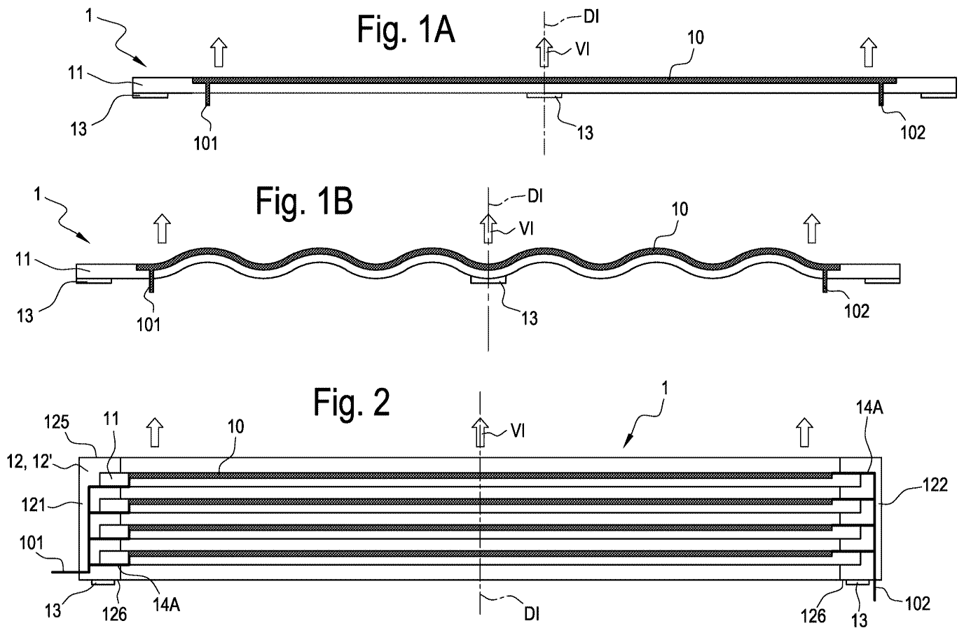

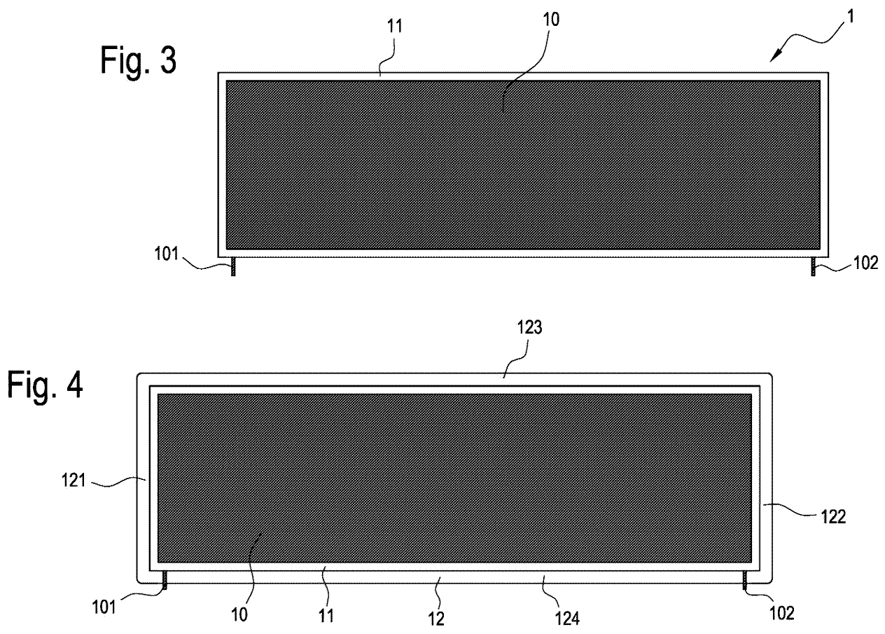

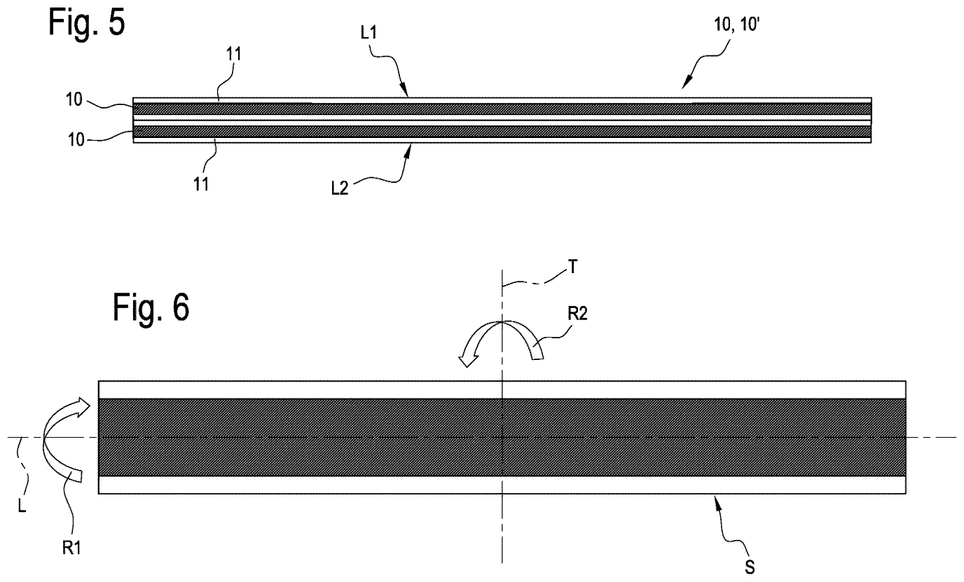

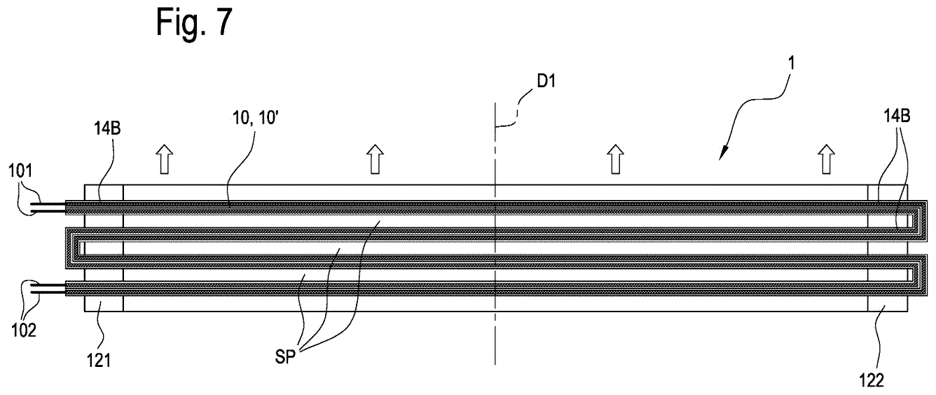

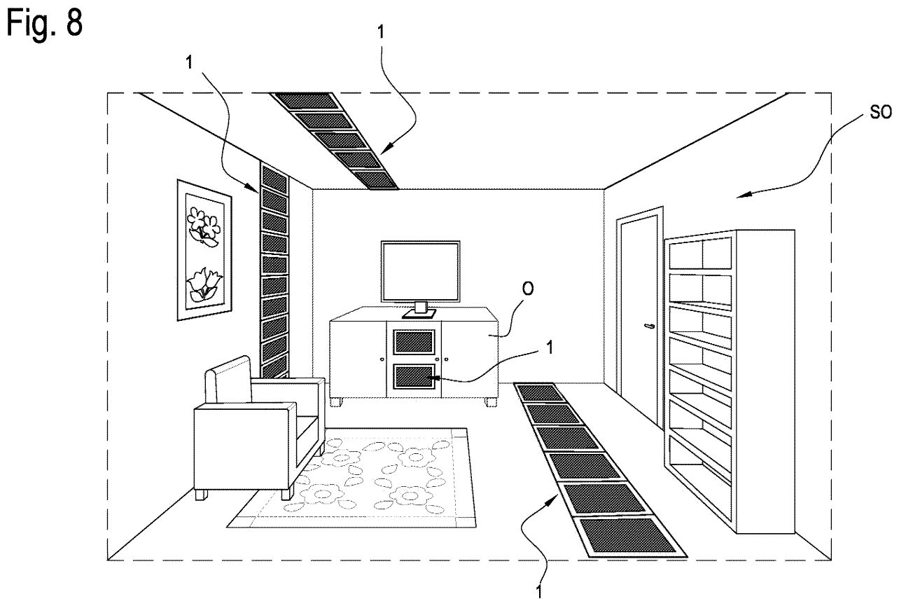

### DETAILED DESCRIPTION OF PREFERRED EMBODIMENTS OF THE INVENTION

With reference to the accompanying drawings, the numeral 1 denotes a radiating apparatus for heating a workspace or an object. In particular, the radiating apparatus is a radiating panel 1.

The radiating panel 1 comprises a conductor 10. The conductor 10 is electrically conductive to allow current to pass through it, thereby heating it by the Joule effect. In a first embodiment, the conductor 10 has the shape of a flat panel (flat sheet, continuous sheet). Preferably, along a radiating direction DI, the conductor has a thickness of less than 100 microns, preferably less than 50 microns, and still more preferably, a thickness of between 23 and 28 microns.

In an embodiment, the conductor 10 directly faces the space to be heated. In some embodiments, there is an insulating layer between the conductor 10 and the surrounding space but there is no substrate material between the conductor 10 and the surrounding space to be heated.

In an embodiment, the panel 1 comprises an input connector 101 and an output connector 102. The input connector 101 is connected to the conductor 10 to supply it with electrical energy. The output connector 102 is connected to the conductor 10 to receive electrical energy from it.

In an embodiment, the apparatus 1 comprises a substrate material 11. The substrate material 11, besides having the function of supporting the conductor 10, also allows it to be insulated from a structure or from the object it is positioned on.

In an embodiment, the substrate material 11 is pliable (not stiff).

Thus, in an embodiment, the substrate material 11 is a panel whose size is at least equal to the size of the conductor 10 (when the latter is a continuous panel). The panel of substrate material 11 is disposed downstream of the conductor 10 along the radiating direction DI in a radiating sense VI. In other words, the conductor 10 faces towards the workspace to be heated, while the substrate material 11 faces towards the structure on which the panel is positioned.

Preferably, the conductor 10 is made (at least) from graphene. Preferably, the graphene 10 is obtained by (nanometric) thermal conversion of the substrate material 11.

Preferably, the substrate material 11 is made from a polymeric material, preferably a polyimide.

The apparatus 1 described above, which is made substantially with the conductor 10 and the substrate material 11, is flexible relative to both of the directions defining the panel 1 so that it can adapt to non-planar surfaces such as, by way of non-limiting example, car upholstery, sofas or other non-planar objects.

According to an aspect of this disclosure, therefore, the panel 1 might also comprise attaching elements 13. The attaching elements 13 are configured to allow connecting the (flexible) panel to a wall, a structure or an object. For example, the attaching elements 13 might be glue-in inserts made using heat-resistant glue. Also imaginable is a solution where the substrate material 11 comprises a contact surface, facing in the sense opposite of the radiating sense, where the contact surface is adhesive (with heat-resistant glue). This allows the panel to be fitted to any type of surface quickly and easily.

In other embodiments, designed more specifically for fitting the panel to flat, rigid structures, the apparatus 1 comprises a framework 12.

The framework 12 is preferably a rigid structure which, although it reduces the flexibility of the apparatus 1, offers a number of important advantages.

In an embodiment, the framework 12 comprises a frame 12′. The frame 12′ comprises four side walls. In particular, the frame 12′ comprises a first side wall 121 and a second side wall 122, opposite and facing each other. The frame 12′ also comprises a third side wall 123 and a fourth side wall 124, also opposite and facing each other.

The side walls of the frame 12′ extend along the radiating direction DI.

In an embodiment, at least two side walls of the frame 12′ comprise respective slots 14A, configured to house the substrate material 11 of a respective continuous sheet of conductor 10.

In particular, each pair of side walls 121, 122 or 123, 124 comprises opposite slots 14A which are configured to house respective opposite portions of the same substrate material 11 which supports a respective conductor sheet 10.

In an embodiment, the apparatus 1 comprises a plurality of conductor units 1′, each including a respective continuous conductor sheet supported by a respective portion of substrate material 11.

The frame 12′ of the framework 12 also comprises a facing surface 125, facing in the radiating sense VI and perpendicular to the radiating direction DI. The frame 12′ comprises a contact surface 126 opposite the facing surface 125. In this case too, there may be attaching elements 13 positioned on the contact surface 126 or there may be an adhesive contact surface.

Each conductor sheet of the conductor units 1′ is supported by respective slots in the side walls of the framework 12. The slots are spaced along the radiating direction DI. Thus, the conductor units 1′ are spaced along the radiating direction DI to define, between the conductor units 1′ themselves, respective spacings SP. These spacings act as heat insulators and prevent the contact surface 126 from reaching very high temperatures.

If there are several conductor units 1′, each one of them is connected to an electrical input collector which is connected to the input connector 101 and which distributes the electric current to all the conductor sheets 10.

In the same way, each of the conductor sheets of the conductor units 1′ is connected to an electrical output collector which is connected to the output connector 102 and which receives the electric current from all the conductor sheets 10.

We note that, in an embodiment, the input connector 101 or the output connector 102 passes through the substrate material 11, for example along a direction perpendicular to the radiating direction DI or along a direction parallel to the radiating direction DI, to come out from the substrate material 11 on the contact surface. In the same way, when the framework 12 is present, the input connector 101 or the output connector 102 passes through the framework along a direction perpendicular to the radiating direction DI to come out from one of the side walls 121, 122, 123 or 124, or along a direction parallel to the radiating direction DI, to come out from the contact surface 126 of the frame 12′.

In an embodiment, the apparatus 1 is very different from the embodiment where it is in sheet form, that is to say, a preferably flat, straight conductor 10′.

The straight conductor 10′comprises the conductor 10 and the substrate material 11 suitably integrated in each other to form the straight conductor 10′.

In a preferred embodiment, the straight conductor 10′is made as described below. The straight conductor 10′comprises a first ply L1 and a second ply L2 juxtaposed along the longitudinal direction of predominant extension L of the straight conductor 10′.

The first and second plies L1, L2 each comprise a flat, straight conductor, made preferably from graphene, which is encapsulated in the substrate material 11. In particular, around each conductor 10 of the first ply L1 and of the second ply L2, there is a first layer of substrate material 11 and a second layer of substrate material 11 welded together on the side of the conductor 10 which is interposed between the two layers.

Alternating electric current passes on each of both the first ply L1 and the second ply L2. In particular, the first ply L1 is traversed by a first alternating electric current, whose vector comprises a respective first modulus and a respective first sense, whilst the second ply L2 is traversed by a second alternating electric current, whose vector comprises a respective second modulus and a respective second sense.

Preferably, the first modulus is the same as the second modulus, whilst the first sense is the opposite of the second sense. This allows balancing the induced magnetic field, whilst the presence of the substrate material allows insulating the electric field.

In an embodiment, the framework 12 comprises a plurality of through cavities 14B which have the same function as the slots 14A of the continuous conductor sheets.

The plurality of through cavities 14B are located on the first side wall 121 and on the second side wall 122, facing each other.

The straight conductor 10′ is supported in the framework by wrapping the straight conductor 10′ round the framework 12 passing by way of the through cavities 14B. In mounting the straight conductor 10′ to the framework, a first end of the straight conductor 10′ is connected to the input connector 101, whilst the other end is connected to the output connector 102.

Thus, the straight conductor 10′ is inserted from the outside to inside of the frames 12′, into a cavity of the plurality of cavities 14B on the first side wall 121 and is then brought to the next cavity 14B on the second side wall 122 to pass from the inside to the outside of the frame 12′. Next, the straight conductor is 10′is folded and its direction inverted to allow reinserting the straight conductor 10′, from the outside to the inside of the frame 12′, through another cavity 14B on the second side wall 122, spaced from the previous one along the radiating direction DI.

This allows forming a coil extending along the radiating direction DI to make several radiating layers.

It is noted that the radiating panel 1 includes a plurality of straight conductors 10′, mounted on the framework 12, parallel to each other and juxtaposed along a direction perpendicular to the radiating direction DI.

In effect, the plurality of cavities 14B on the frame are also spaced along a direction perpendicular to the radiating direction DI. In particular, the cavities 14B aligned along the radiating direction DI are used for the same straight conductor 10′, whilst the cavities 14B aligned perpendicularly to the radiating direction DI are used for distinct straight conductors 10′.

According to an aspect of it, this disclosure also provides a method for making a radiating apparatus 1.

The method comprises a step of making a conductor. The step of making the conductor 10 is preferably a step of (nanometric) thermal conversion. In the step of thermal conversion, a support of substrate material 11, which is preferably made from a polymeric material (a polyimide, for example) is placed on a working surface and nanometrically restructured by an electromagnetic wave, causing the polymeric material to be converted to a carbon based material, preferably graphene.

The substrate material 11 may be in the form of a panel, to make the continuous conductor sheet by thermally converting all of the inside surface of the substrate material 11, or in the form of a continuous strip, to obtain the straight conductor 10′ by thermally converting the inside surface of the continuous strip.

After obtaining the graphene conductor 10, the method comprises connecting the conductor 10 to the input connector 101 and the to the output connector 102.

Next the method optionally comprises positioning the continuous sheet in the slots 14A of the framework 12.

In the case of the straight conductor 10′, on the other hand, the method comprises wrapping it on the framework 12 in the cavities 14B, as described above.

In addition to what has already been described, the method also provides a method for making the straight conductor 10′.

The steps described here follow the step of thermal conversion of the continuous strip. Thus provided is a strip of substrate material 11 on which there is also the thermally converted conductor 10, which is spaced along a transverse direction T from the edge of the continuous strip of material 11, to define a first welding edge BS1 and a second welding edge BS2.

At this point, the method comprises a first step R1 of rotating the continuous strip about the longitudinal axis L so as to lay the first welding edge BS1 over the second welding edge BS2. The first welding edge BS1 and the second welding edge BS2 are then welded, glued or otherwise attached to each other so as to encapsulate the conductor 10 inside the substrate material 11. This allows obtaining a third welding edge.

In an embodiment, the method comprises a second step R2 of rotating, about the transverse direction T, so as to fold the third welding edge on itself.

Next, the method comprises welding the third welding edge onto itself so as to define two conductive stretches, juxtaposed along the longitudinal direction L, as described above with reference to the straight conductor 10′.

1. A radiating apparatus for heating a workspace or an object, comprising:
a substrate material, configured to be attached to a structure of the workspace or to a surface of the object;
a conductor, associated with the substrate material and configured to receive an electric current, the conductor extending in a plane to define a radiating surface of the radiating apparatus,
wherein the conductor is a flat conductor made from a carbon-based material.

2. The apparatus according to claim 1, wherein the substrate material is made from a polymeric, fireproof, electrically insulating material.

3. The apparatus according to claim 2, wherein the substrate material is made from a polyimide and wherein the conductor is made from graphene.

4. The apparatus according to claim 1, wherein the conductor is made, starting from the substrate material, by nanometric thermal conversion of the substrate material in the carbon-based material.

5. The apparatus according to claim 1, wherein the conductor comprises a continuous sheet that defines the radiating surface of the radiating apparatus.

6. The apparatus according to claim 5, wherein the continuous sheet has a thickness of less than 30 microns.

7. The apparatus according to claim 4, comprising a framework on which the conductor is disposed, and wherein the conductor comprises a flat, straight conductor wrapped around the framework to define the radiating surface.

8. The apparatus according to claim 7, wherein the framework comprises a frame, including four side walls and a plurality of through cavities, made in at least two of the side walls of the frame, wherein the flat, straight conductor is wrapped around the framework and inserted in the through cavities of the frame.

9. The apparatus according to claim 4, wherein the flat, straight conductor comprises:
a first flat conductor, encapsulated in the substrate material and traversed by a first electric alternating current;
a second flat conductor, encapsulated in the substrate material and traversed by a second electric alternating current, having a sense that is the opposite of the first electric alternating current,
wherein the first and the second conductor are juxtaposed with each other along a main longitudinal direction of extension, to define the flat straight conductor.

10. A structural heating element for building construction, comprising a structure and a heating apparatus according to claim 1, which is attached to the structure of the structural element.

11. A method for making a radiating apparatus for heating a workspace or an object, the method comprising the following steps:
providing a substrate material;
disposing a conductor on the substrate material, wherein the conductor is a flat conductor made from a carbon-based material,
the method being characterized in that the step of disposing the conductor on the substrate material is a step of nanometric thermal conversion, wherein part of the substrate material is thermally converted into the carbon-based material of the conductor.
